(19) United States
(12) Patent Application Publication
(10) Pub. No.: US 2018/0313469 A1
(43) Pub. Date: Nov. 1, 2018

(54) APPARATUS FOR ROUTING CABLES THROUGH A CABLE SUPPORT SYSTEM

(71) Applicant: Cable Management Solutions Inc., Bayshore, NY (US)

(72) Inventor: Roger Jette, East Islip, NY (US)

(21) Appl. No.: 15/959,542

(22) Filed: Apr. 23, 2018

Related U.S. Application Data
(60) Provisional application No. 62/491,720, filed on Apr. 28, 2017.

(51) Int. Cl. F16L 3/10; F16L 3/26

(52) U.S. Cl. CPC F16L 3/1066; F16L 3/26

(57) ABSTRACT

An apparatus configured to facilitate routing of one or more cables through a cable support system includes a head and a pull assembly. The head includes a barrel defining a longitudinal axis and having forward and rear end portions. The head further includes a plurality of arms engaged to the barrel, radially-spaced about the longitudinal axis, extending rearwardly of the barrel, and defining an interior area therebetween. The pull assembly is operably coupled to the head and includes an elongated member extending forwardly of the head and a base disposed within the interior area and configured to operably engage an end portion of at least one cable within the interior area.

### CROSS-REFERENCE TO RELATED APPLICATIONS

This application claims the benefit of U.S. Provisional Patent Application No. 62/491,720, titled “Apparatus for Routing Cables Through a Cable Support System” and filed on Apr. 28, 2017, the entire contents of which is hereby incorporated herein by reference.

### BACKGROUND

### Technical Field

The present disclosure relates to cable support systems. More particularly, the present disclosure relates to an apparatus facilitating the routing of cables through a cable support system.

### Description of Related Art

Due to the increasing usage of communication, data, and other cable-dependent systems, greater numbers of cables are required to interconnect the various systems with one another and with their various peripheral devices. As a result, various cable support systems have been developed to deal with the task of organizing and routing the numerous cables to their destinations.

Once the cable support system is installed as required, it is often necessary to route one or more cables or bundles of cables through the cable support system to interconnect the various cable-dependent systems with one another and their various peripheral devices. Routing such cables and/or cable bundles can be a tedious, time-consuming process and/or prove difficult as cables and cable bundles can become snagged on the cable support system itself or previously-routed cables or cable bundles.

### SUMMARY

To the extent consistent, any of the aspects detailed herein may be used in conjunction with any or all of the other aspects detailed herein.

An apparatus configured to facilitate routing of one or more cables through a cable support apparatus provided in accordance with aspects of the present disclosure includes a head and a pull assembly. The head includes a barrel and a plurality of arms. The barrel defines a longitudinal axis and includes a forward end portion and a rear end portion. The arms are engaged to the barrel, radially-spaced about the longitudinal axis, extend rearwardly of the barrel, and define an interior area therebetween. The pull assembly is operably coupled to the head and includes an elongated member and a base. The elongated member extends forwardly of the head while the base is disposed within the interior area and configured to operably engage an end portion of at least one cable within the interior area.

In an aspect of the present disclosure, the pull assembly further includes a sock extending rearwardly from the base and configured to at least partially surround the end portion of the at least one cable. In such aspects, the base may be disposed about an end portion of the sock to engage the end portion of the at least one cable therein.

In another aspect of the present disclosure, the elongated member of the pull assembly is engaged to the base rearwardly of the barrel of the head and extends through a lumen defined through the barrel of the head forwardly of the barrel.

In another aspect of the present disclosure, each of the plurality of arms is outwardly-bowed relative to the longitudinal axis such that the interior area defines a bulbous configuration.

In yet another aspect of the present disclosure, each of the plurality of arms is flexible.

In still another aspect of the present disclosure, the barrel defines a cylindrical configuration.

In still yet another aspect of the present disclosure, each of the plurality of arms extends longitudinally along a portion of an outer surface of the barrel and is welded to the outer surface of the barrel.

A system provided in accordance with aspects of the present disclosure includes a cable support apparatus and a cable routing apparatus. The cable support apparatus defines a longitudinal passageway for retaining one or more cables therein. The cable routing apparatus includes a head including a barrel and a plurality of arms engaged to the barrel and extending therefrom. The cable routing apparatus further includes a pull assembly operably coupled to the head and configured to operably engage an end portion of at least one cable. The pull assembly includes an elongated member extending forwardly of the head. The elongated member of the pull assembly is configured to pull the head through the longitudinal passageway to thereby pull the end portion of the at least one cable through the longitudinal passageway while the plurality of arms of the head facilitate centering of the cable routing apparatus within the longitudinal passageway.

In an aspect of the present disclosure, the pull assembly further includes a sock configured to at least partially surround the end portion of the at least one cable. In such aspects, the pull assembly further includes a base coupled between the sock and the elongated member. Further still, the elongated member of the pull assembly may be engaged to the base rearwardly of the barrel of the head and extend through a lumen defined through the barrel of the head forwardly of the barrel.

In another aspect of the present disclosure, each of the plurality of arms is outwardly-bowed such that the plurality of arms cooperate to define a largest-diameter portion of the cable routing apparatus. In such aspects, a diameter of the largest-diameter portion of the cable routing apparatus may generally approximate a diameter of the longitudinal passageway of the cable support apparatus.

In another aspect, each of the plurality of arms is flexible.

In still another aspect, the cable support apparatus includes an elongated spine and a plurality of support members spaced-apart along a length of the elongated spine. The support members cooperate with one another to define the longitudinal passageway extending along the length of the elongated spine.

### BRIEF DESCRIPTION OF THE DRAWINGS

Various aspects and features of the present disclosure are described herein with reference to the drawings, wherein like reference numerals identify similar or identical elements and:

FIG. 1 is a perspective view of a cable routing apparatus provided in accordance with the present disclosure, including a cable bundle operably coupled thereto;

FIG. 2 is an enlarged, perspective view of a head of the cable routing apparatus of FIG. 1;

FIG. 3A is a side view illustrating the initial routing of the cable bundle of FIG. 1 through a cable support system using the cable routing apparatus of FIG. 1;

FIG. 3B is a side view illustrating further routing of the cable bundle of FIG. 1 through the cable support system of FIG. 3A; and

FIG. 3C is a side view illustrating routing of a second cable bundle through the cable support system of FIG. 3A.

### DETAILED DESCRIPTION

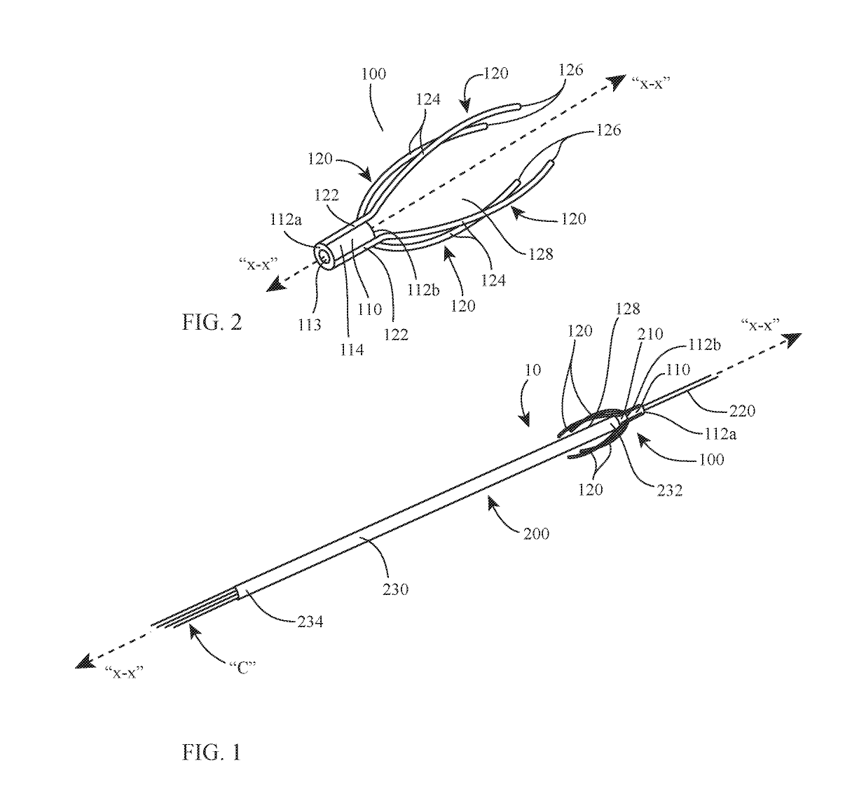

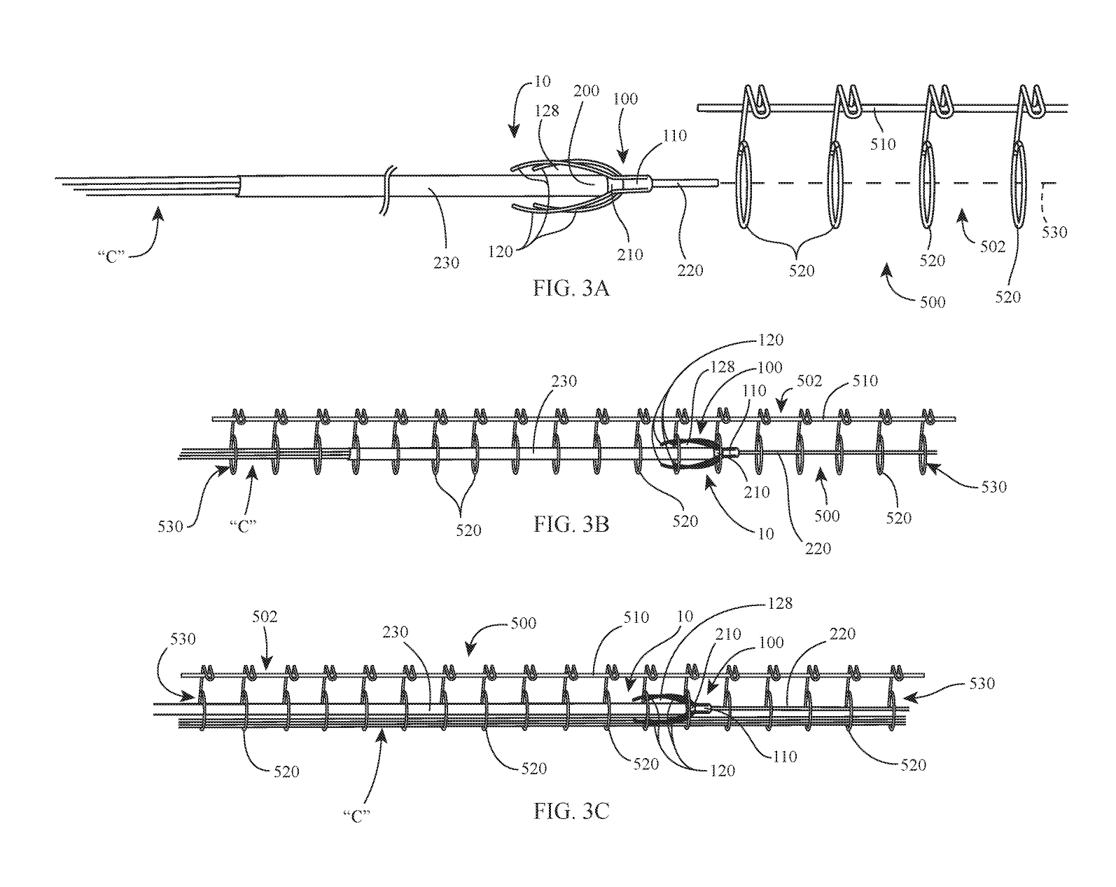

Turning now to FIGS. 1-2, a cable routing apparatus provided in accordance with the present disclosure and configured to facilitate the routing of cables “C” through a cable support system 500 (FIGS. 3A-3C) is shown generally identified by reference numeral 10. Although detailed hereinbelow for use with cable support system 500 (FIGS. 3A-3C), cable routing apparatus 10 may likewise be used for routing one or more cables “C” through any suitable cable support system.

Cable routing apparatus 10 includes a head 100 defining a longitudinal axis “X-X” and a pull assembly 200 configured to operably couple to head 100. Pull assembly 200, as detailed below, includes a base 210, an elongated member 220 configured to extend from base 210 through head 100 and forwardly thereof along longitudinal axis “X-X,” and a sock 230 configured to extend from base 210 rearwardly of head 100 about longitudinal axis “X-X.”

With reference in particular to FIG. 2, head 100 of cable routing apparatus 10 includes a barrel 110 and a plurality of arms 120 extending from barrel 110. Barrel 110 defines longitudinal axis “X-X” therethrough and includes a forward end portion 112a and a rear end portion 112b, both of which are aligned on longitudinal axis “X-X.” Barrel 110 has a generally tubular configuration, and defines a lumen 113 extending longitudinally therethrough.

Arms 120 of head 100 are radially-spaced about barrel 110. More specifically, arms 120 are welded or otherwise engaged to an outer cylindrical surface 114 of barrel 110. Although four (4) arms 120 are illustrated in the drawings, it is contemplated that any suitable number of arms 120 may be provided. Each arm 120 defines a flexible configuration formed from a single piece of wire stock, e.g. stainless steel wire, and includes a fixed end portion 122 engaged to outer cylindrical surface 114 of barrel 110, a body portion 124 extending from fixed end portion 122 rearwardly of barrel 110, and a free end portion 126 spaced-apart from the rear end potion 112b of barrel 110.

Continuing with reference to FIG. 2, fixed end portions 122 of arms 120 may extend longitudinally along outer cylindrical surface 114 of barrel 110 and may be welded or otherwise engaged thereto. As noted above, fixed end portions 122 are radially-spaced about barrel 110. Fixed end portions 122 may be equally-spaced about barrel 110 or arranged in any other suitable configuration about barrel 110.

Body portions 124 of arms 120 extend from the respective fixed end portions 122 of arms 120 and barrel 110 rearwardly of barrel 110 about longitudinal axis “X-X.” Body portions 124 define arcuate configurations wherein each body portion 124 bows radially outwardly relative to the fixed and free end portions 122, 126 of the respective arm 120. More specifically, body portions 124 bow outwardly beyond the outer dimensions of barrel 110 and cooperate to define a bulbous configuration. The bulbous configuration formed by body portions 124 of arms 120 defines an interior area 128.

Referring again to FIG. 1, pull assembly 200, as noted above, is configured to operably couple to head 100 and includes a base 210, an elongated member 220, and a sock 230.

Base 210 of pull assembly 200 is configured for positioning within the interior area 128 defined by body portions 124 of arms 120 of head 100. Base portion 210, more specifically, is configured for positioning adjacent rear end portion 112b of barrel 110 of head 100 and defines a diameter greater than a diameter of lumen 113 of barrel 110 such that base 210 is inhibited from passing forwardly through lumen 113.

Elongated member 220 is attached to and extends from base 210 through lumen 113 of barrel 110 of head 100 and forwardly therefrom along longitudinal axis “X-X.” Elongated member 220 may be permanently attached to base 210 (via adhesion, mechanical engagement, or formation therewith) or may be releasable therefrom (via any suitable structure, material, or mechanism). Elongated member 220 may be a rope, cable, tube, or other suitable flexible elongated component and defines a diameter less than the diameter of lumen 113 of barrel 110 to enable elongated member 220 to extend through lumen 113 of barrel 110. As such, with base 210 disposed rearwardly of barrel 110, inhibited from passing therethrough, and with elongated member 220 extending from through lumen 113 of barrel 110 forwardly therefrom, pulling of elongated member 220 in a forward direction along longitudinal axis “X-X” likewise pulls head 100 in a forward direction along longitudinal axis “X-X.” Elongated member 220 is flexible to facilitate manipulation thereof and, as detailed below, is configured to facilitate pulling cable routing apparatus 10 and one or more cables “C” coupled thereto through a cable support system 500 (FIGS. 3A-3C).

Continuing with reference to FIG. 1, sock 230 of pull assembly 200 is attached to base 210 and extends rearwardly from base 210 and head 100 about longitudinal axis “X-X.” Sock 230 defines a generally tubular configuration and may be formed from a mesh, fabric, or other suitable material. Sock 230 defines a forward end portion 232 configured to engage base 210, and a rear end portion 234. The material of sock 230 may be wrapped about the end portion of one or more cables “C” to form sock 230 therearound, or sock 230 may be configured to receive the end portion of one or more cables “C” through rear end portion 234 thereof. Sock 230 is configured to extend rearwardly beyond arms 120 of head 100 and about cables “C” over a portion of the length thereof.

Base 210 may be engagable about sock 230 under compression to enclose forward end portion 232 of sock 230 and retain the end portions of cables “C” therein under compression. Alternatively or additionally, a suitable retention component, e.g., strap, tie, clamp, etc., associated with sock 230 and/or base 210 may be provided for releasably engaging the end portions of the cables “C” within sock 230. Further still, base 210 may be an integral part of sock 230 formed from the bunched, closed forward end portion 232 of sock 230.

In embodiments where the material of sock 230 is wrapped about the one or more cables “C” to form sock 230 therearound, the material for sock 230 may be provided on a spool (not shown), allowing the user to wrap an appropriate amount of material about the cables “C” to form sock 230 and then cut the material from the spool (not shown).

Turning to FIGS. 3A-3C, in conjunction with FIGS. 1 and 2, the use of cable routing apparatus 10 to route one or more cables “C” through a cable support system 500 is described. For the purposes herein, cable support system 500 is generally described, keeping in mind, as noted above, that cable routing apparatus 10 may likewise be used for routing one or more cables “C” through any suitable cable-supporting apparatus such as a pipe (e.g., PVC or other suitable pipe), tube (e.g., electrical metallic tubing (EMT)), or other suitable cable-supporting apparatus made of any suitable material, e.g., metal or plastic.

Initially, cable routing apparatus 10 is assembled and one or more cables “C” engaged thereto. In order to assemble apparatus and engage the one or more cables “C” thereto, sock 230 is disposed about end portions of the one or more cables “C.” For example, the material forming sock 230 may be rolled up about the end portions of the one or more cables “C” to form sock 230 thereabout. Base 210 is attached to sock 230 and elongated member 220 to couple sock 230 and elongated member 220 with one another. If not already accomplished, the end portions of the one or more cables “C” are secured within sock 230. Elongated member 220 is routed through lumen 113 of barrel 110 of head 100. The above-noted assembly may be performed in any suitable order. Once cable routing apparatus 10 is assembled with one or more cables “C” engaged thereto, cable routing apparatus 10 may be routed through a cable support system 500, as detailed below.

Cable support system 500 includes one or more cable support apparatuses 502 each including an elongated flexible spine 510 having a plurality of spaced-apart support members 520 disposed along the length of elongated flexible spine 510. Flexible spine 510 may be manipulated to define any suitable configuration of cable support system 500, e.g., to allow the cable support apparatus 502 to snake over and around obstacles. Support members 520 cooperate to define a longitudinal passageway 530 extending along the length of flexible spine 510. Support members 520 may be configured such that longitudinal passageway 530 defines a circular cross-sectional configuration, as shown, although it is also contemplated that longitudinal passageway 530 defines a rectangular cross-sectional configuration, another polygonal cross-sectional configuration, or any other suitable configuration. The one or more cable support apparatuses 502 may be joined to one another in end-to-end fashion and/or in intersecting fashion to form a cable support system 500 having any suitable configuration.

In embodiments, cable routing apparatus 10 may be configured such that the largest diametered portion thereof (defined by the outwardly-bowed arms 120 of head 100) generally approximates the diameter of longitudinal passageway 530 (as defined by the plurality of support members 520). Generally approximates, for the purposes herein, is within about 20%. As such, in embodiments where the largest diametered portion of cable routing apparatus 10 generally approximates the diameter of longitudinal passageway 530, the diameter of the largest diametered portion of cable routing apparatus 10 is within a difference of plus or minus 20% of the diameter of longitudinal passageway 530.

With particular reference to FIG. 3A, in order to route the one or more cables “C” through cable support system 500, elongated member 220 of cable routing apparatus 10 is pulled into and through the longitudinal passageway 530 defined by the cable support apparatus(es) 502 of cable support system 500. With additional reference to FIG. 3B, as elongated member 220 of cable routing apparatus 10 is pulled into and through longitudinal passageway 530, excursions of head 100 of cable routing apparatus 10 may result from a change in direction of the cable support apparatus 502, changing configuration of cable support system 500, other cables (or components) disposed within the cable support apparatus 502, etc. Arms 120 of head 100 of cable routing apparatus 10 account for these excursions and function to re-center head 100 within longitudinal passageway 530 to facilitate routing of cables “C” therethrough and inhibit snagging. More specifically, the radially-arranged, flexible, bowed arms 120 are configured to contact the support members 520 of cable support apparatus 502, or other components or obstacles, and bias head 100 back towards a generally centered orientation within cable support apparatus 502. As a result of this configuration, the cables “C” are inhibited from catching or snagging on previously-laid cables, other components, and/or obstacles, while the smooth, bowed outer surfaces of arms 120 facilitate movement of cable routing apparatus 10 through cable support apparatus 502 with minimal resistance. In addition, with arms 120 surrounding interior area 128 and with the end portions of cables “C” secured within sock 230 within interior area 128, the end portions of cables “C” are maintained spaced-apart from previously laid cables and other components disposed within longitudinal passageway 530, inhibiting snagging or tangling therewith. Sock 230 also inhibits such snagging or tangling.

With reference to FIG. 3C, once cables “C” has been routed through cable support apparatus(es) 502 of cable support system 500 as desired, cable routing apparatus 10 may be disengaged from the end portions of cables “C,” reinstalled about another set of one or more cables (not shown) and pulled through the cable support apparatus(es) 502 of cable support system 500 to route that set of one or more cables (not shown) therethrough.

The above-detailed use of cable routing apparatus 10 applies similarly to use of cable routing apparatus 10 for routing one or more cables “C” through any suitable cable-supporting apparatus such as a pipe (e.g., PVC or other suitable pipe), tube (e.g., electrical metallic tubing (EMT)), or other suitable cable-supporting apparatus made of any suitable material, e.g., metal or plastic.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed:

1. An apparatus configured to facilitate routing of one or more cables through a cable support apparatus, comprising:
a head, including:
a barrel defining a longitudinal axis and including a forward end portion and a rear end portion; and
a plurality of arms engaged to the barrel, the plurality of arms radially-spaced about the longitudinal axis, extending rearwardly of the barrel, and defining an interior area therebetween; and
a pull assembly operably coupled to the head, the pull assembly including:
an elongated member extending forwardly of the head; and
a base disposed within the interior area and configured to operably engage an end portion of at least one cable within the interior area.

2. The apparatus according to claim 1, wherein the pull assembly further includes a sock extending rearwardly from the base and configured to at least partially surround the end portion of the at least one cable.

3. The apparatus according to claim 2, wherein the base is disposed about an end portion of the sock to engage the end portion of the at least one cable therein.

4. The apparatus according to claim 1, wherein the elongated member of the pull assembly is engaged to the base rearwardly of the barrel of the head and extends through a lumen defined through the barrel of the head forwardly of the barrel.

5. The apparatus according to claim 1, wherein each of the plurality of arms is outwardly-bowed relative to the longitudinal axis such that the interior area defines a bulbous configuration.

6. The apparatus according to claim 1, wherein each of the plurality of arms is flexible.

7. The apparatus according to claim 1, wherein the barrel defines a cylindrical configuration.

8. The apparatus according to claim 7, wherein each of the plurality of arms extends longitudinally along a portion of an outer surface of the barrel and is welded to the outer surface of the barrel.

9. A system, comprising:
a cable support apparatus defining a longitudinal passageway for retaining one or more cables therein; and
a cable routing apparatus, including:
a head including a barrel and a plurality of arms engaged to the barrel and extending therefrom; and
a pull assembly operably coupled to the head and configured to operably engage an end portion of at least one cable, the pull assembly including an elongated member extending forwardly of the head,
wherein the elongated member of the pull assembly is configured to pull the head through the longitudinal passageway to thereby pull the end portion of the at least one cable through the longitudinal passageway while the plurality of arms of the head facilitate centering of the cable routing apparatus within the longitudinal passageway.

10. The system according to claim 9, wherein the pull assembly further includes a sock configured to at least partially surround the end portion of the at least one cable.

11. The system according to claim 10, wherein the pull assembly further includes a base coupled between the sock and the elongated member.

12. The system according to claim 11, wherein the elongated member of the pull assembly is engaged to the base rearwardly of the barrel of the head and extends through a lumen defined through the barrel of the head forwardly of the barrel.

13. The system according to claim 9, wherein each of the plurality of arms is outwardly-bowed such that the plurality of arms cooperate to define a largest-diameter portion of the cable routing apparatus.

14. The system according to claim 13, wherein a diameter of the largest-diameter portion of the cable routing apparatus generally approximates a diameter of the longitudinal passageway of the cable support apparatus.

15. The system according to claim 9, wherein each of the plurality of arms is flexible.

16. The system according to claim 9, wherein the cable support apparatus includes an elongated spine and a plurality of support members spaced-apart along a length of the elongated spine, the support members cooperating with one another to define the longitudinal passageway extending along the length of the elongated spine.
